(19) United States
(12) Patent Application Publication
(10) Pub. No.: US 2011/0022414 A1
(43) Pub. Date: Jan. 27, 2011

(54) METHOD AND APPARATUS FOR PERSONALLY CONTROLLED SHARING OF MEDICAL IMAGE AND OTHER HEALTH DATA

(76) Inventors: Yaorong Ge, Winston-Salem, NC (US); John Jeffrey Carr, Winston-Salem, NC (US)

Correspondence Address: JENKINS, WILSON, TAYLOR & HUNT, P. A., 3100 Tower Blvd., Suite 1200, DURHAM, NC, 27707, US

(21) Appl. No.: 12/827,717

(22) Filed: Jun. 30, 2010

Related U.S. Application Data
(60) Provisional application No. 61/222,085, filed on Jun. 30, 2009.

(51) Int. Cl. G06Q 50/00; G06Q 10/00; H04L 9/32; G06F 21/00; G06F 15/16

(52) U.S. Cl. 705/3; 726/7; 235/380

(57) ABSTRACT

A method and apparatus for personally controlled sharing of medical image and other health data are disclosed. According to one aspect, the subject matter described herein includes a method for patient mediated access to patient health information maintained by different healthcare facilities and other health record repositories. The methods includes, using a central key server and a plurality of data servers local to healthcare facilities and other health record repositories. At the central key server, a patient controlled registry of access keys that control access to patient health information maintained by different healthcare facilities is provided. The central key server receives, from a data server of a first healthcare facility, a request for an access key that controls access to health information for a patient maintained by a second healthcare facility. In response to the request, the central key server authenticates credentials of the patient and the first healthcare facility, verifies permission from the patient to release the access key to the first healthcare facility, locates the access key for the health information for the patient at the second healthcare facility, and provides the access key to the first healthcare facility. The access key is used by the data server of the first healthcare facility to obtain health information for the patient directly from the data server of the second healthcare facility after successful authentication and verification by the second healthcare facility.

### PRIORITY CLAIM

This application claims the benefit of U.S. Provisional Patent Application Ser. No. 61/222,085, filed Jun. 30, 2009; the disclosure of which is incorporated herein by reference in its entirety.

### TECHNICAL FIELD

The subject matter described herein relates to sharing medical image and other health data. More particularly, the subject matter described herein relates to method and apparatus for personally controlled sharing of medical image and other health data.

### BACKGROUND

Sharing medical images across healthcare enterprises can not only improve the quality of clinical care but also reduce the cost [1]. When images scanned from other institutions and associated reports are readily available, physicians are better able to decide whether or not to prescribe new imaging procedures. This reduction of repeated imaging procedures not only saves healthcare cost but also protects patients from unnecessary exposure to radiation or other risks. If new images are deemed necessary for a patient, the availability of prior studies from other institutions allows a radiologist to make more accurate diagnoses by identifying relevant changes from prior images. Furthermore, if images are easily accessible from both a rural hospital and a tertiary care medical center, physicians from the rural hospital can provide timely diagnosis and treatment for rural patients by obtaining specialty consultation remotely while saving the cost of physically transferring patients. Most would agree that, when images are shared as a part of consolidated electronic health records (EHRs), even more benefits can be realized in the delivery of high quality healthcare at lower cost. Nevertheless, while general EHRs still lack standards for interoperability, radiology images are actually more ready for sharing due to the adoption of the DICOM standards (Digital Imaging and Communications in Medicine).

The past five years have seen significant efforts throughout the nation in developing innovative infrastructures for secure sharing of patient health information among providers, patients, payers, and government agencies. Most of these efforts were conducted as a part of the Regional Health Information Organization (RHIO) and Health Information Exchange (HIE). Among the more than 100 RHIO/HIE projects, only a few have included or focused on sharing radiology images. The most well-known image sharing project is the Philadelphia Health Information Exchange (PHIE), originally funded by NIH to enable virtual consults across different facilities. The PHIE is based on the Diagnostic Imaging Exchange platform developed by Hx Technologies. It is currently operational and serving 7 healthcare facilities in the Philadelphia area, allowing secure access by any member of the participating facilities to some 7.5 million imaging studies across 500,000 unique patients. More recently, the same technologies are being deployed at the New Jersey Health Information Exchange. Other RHIO efforts on image sharing include Rochester RHIO's announcement to enable image sharing among 8 providers and The Tennessee eHealth Exchange Zone's plan to integrate imaging data state-wide during 2008-2009 time frame. In addition to RHIO efforts in the U.S., other countries have commenced similar initiatives in recent years. Most notable is Canada Health Infoway's effort to implement a national, interoperable electronic health record system that includes radiology imaging as a core component.

Almost all image sharing projects follow the standard profiles developed by the Integrating the Healthcare Enterprise (IHE) initiative. The main profiles include Cross-enterprise Document Sharing for Imaging (XDS-I) and Patient Identifier Cross-reference (PIX). According to the IHE model, participants of an image sharing effort first form an Affinity Domain which defines a common set of policies for data sharing and patient identification and share a common infrastructure for data repository and registry. Within this affinity domain, individual participants submit standard metadata of each generated image to the shared infrastructure while maintaining the actual image data locally. The shared infrastructure pools all the metadata together and provides essential services for secure access by all members of the affinity domain. These services include master patient index, node authentication and audit trails. When desired images are found from the metadata repositories, actual image data are fetched from the source facility via a peer-to-peer DICOM protocol.

While initial efforts of image sharing have been promising in a small number of regional consortiums, major questions remain as to the best approach to implement image sharing in larger scale and more diverse environments. A significant issue is the concept of Affinity Domain. As the number of participants grows and as the number of affinity domains grows, the negotiation of common policies and management of changes and exceptions can become exponentially more complex and quickly overwhelm available resources.

Accordingly, what is needed is a method and apparatus for personally controlled sharing of medical image and other health data.

### SUMMARY

According to one aspect, the subject matter described herein includes a method for patient mediated access to patient health information maintained by different healthcare facilities and other health record repositories. The method includes, using a central key server and a plurality of data servers local to healthcare facilities and other health record repositories. At the central key server, a patient controlled registry of secure access keys that control access to patient health information maintained by different healthcare facilities is provided. The central key server receives, from a data server of a first healthcare facility, a request for an access key that controls access to health information for a patient maintained by a second healthcare facility. In response to the request, the central key server authenticates credentials of the patient and the first healthcare facility, verifies permission from the patient to release the access key to the first healthcare facility, locates the access key for the health information for the patient at the second healthcare facility, and provides the access key to the first healthcare facility. The access key is used by the data server of the first healthcare facility to obtain health information for the patient directly from the data server of the second healthcare facility. After receiving the request from the first healthcare facility, the second healthcare facility verifies the authenticity of the presented key which should be one issued by the facility, the credentials of the patient and the first healthcare facility, the patient's consent to release the medical image and other health data, and the policy of the second healthcare facility regarding data security and data export. When verification of all steps succeeds, the second healthcare facility transfers the requested medical image and other health data to the first healthcare facility in a secure manner.

The subject matter described herein for providing personally controlled sharing of medical image and other health data may be implemented using a non-transitory computer readable medium having stored thereon executable instructions that when executed by the processor of a computer control the computer to perform steps. Exemplary non-transitory computer readable media suitable for implementing the subject matter described herein include disk memory devices, chip memory devices, programmable logic devices, and application specific integrated circuits. In addition, a computer readable medium that implements the subject matter described herein may be located on a single device or computing platform or may be distributed across plural devices or computing platforms.

### BRIEF DESCRIPTION OF THE DRAWINGS

Preferred embodiments of the subject matter described herein will now be explained with reference to the accompanying drawings of which:

FIG. 1 is a block diagram illustrating an exemplary system for patient mediated access to patient health information according to an embodiment of the subject matter describer herein;

FIG. 2 is a block diagram illustrating patient mediated access to health information maintained by different facilities according to an embodiment of the subject matter describer herein;

FIG. 3 is a block diagram comparing patient mediated access to health records maintained by different facilities to conventional centralized storage of patient health records;

FIG. 4 is a block diagram illustrating an exemplary model for implementing a facilities portal according to an embodiment of the subject matter describer herein;

FIG. 5 is a block diagram illustrating patient mediated access to health records maintained at different facilities using call-based access according to an embodiment of the subject matter describer herein; and

FIG. 6 is a flow chart illustrating an exemplary method for patient mediated access to patient health information maintained by different facilities according to an embodiment of the subject matter describer herein.

### DETAILED DESCRIPTION

In terms of technology, the recent push toward personally controlled health records (PCHR) presents exciting opportunities for new models of health information interoperability. In this model, patients play a vital role in consolidating and managing their own health records and making them available for healthcare providers and researchers [2]. We believe this model can dramatically simplify data sharing processes and policies, especially in cross affinity domain scenarios, because providers are no longer required to enter into prior negotiated affinity domain arrangements. Allowing patients to link their identities at different providers also greatly simplifies or even eliminates the need for the master patient indexing process which is generally considered one of the major technical challenges in cross-enterprise data sharing. In fact, some recent RHIOs, such as the Louisville Health Information Exchange have already started implementing the Health Record Bank (HRB) concept based on this model.

Personally controlled approaches to sharing health records where health records are consolidated and stored centrally are not new. Several commercial products for personal health records (PHRs) are already in the market, although they only address non-imaging related records at this point. We are also aware that projects have been proposed to demonstrate the feasibility of sharing images using the existing PHR approach for sharing personal health records.

However. PHR is only one of the approaches that enables personally controlled data sharing. As explained above, personal health records currently use a simple push model. That is, after a user sets up the sharing request, facilities are supposed to push all relevant health records to the designated PHR. Direct use of existing PHRs for image sharing means that a copy of every piece of image and other health data will be pushed to the PHR from every facility. As imaging technology improves and imaging volume increases, this redundant storage space can become enormous. Furthermore, using the simple push model, facilities will need to re-transfer large amount of image data every time they are updated. If a data set is mistakenly transferred to the PHR account, it will be difficult to correct the error without user involvement.

From our perspective, a more serious pitfall in the PHR approach is the requirement that users must have sufficient technology and knowledge to manage the collection and transfer of their records. Without proper resolution, this approach will inevitably further widen the digital divide in this country especially in disadvantaged regions.

In the following sections, we describe a new approach for personally controlled sharing of medical imaging data. We note that the same methods apply to sharing or all other health data.

Personally Controlled Access Registry for EHRs (PCARE)

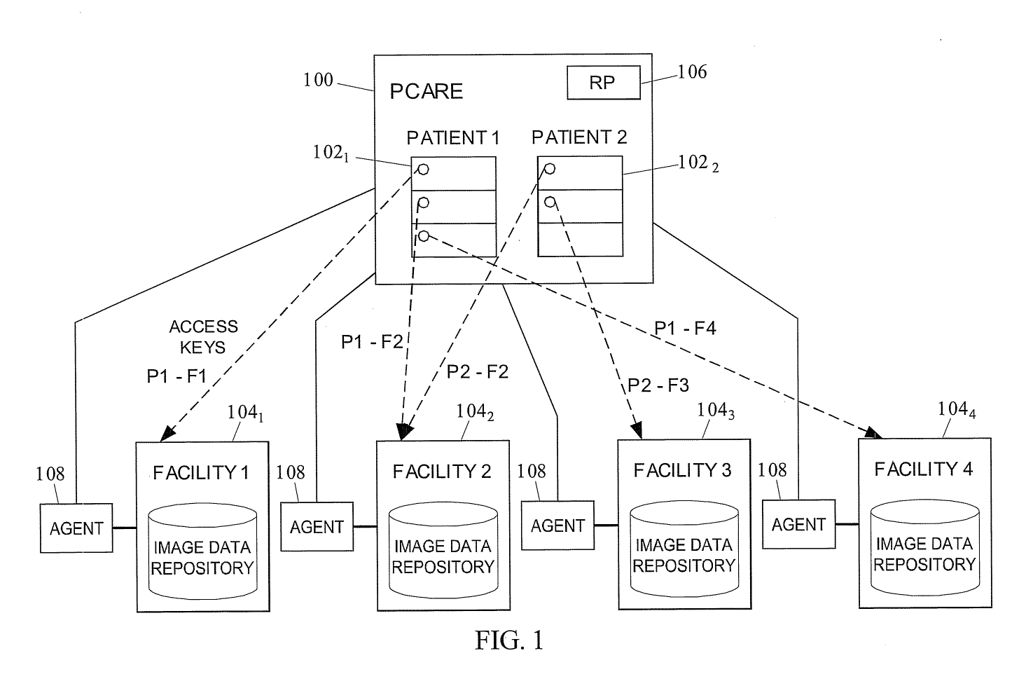

As the title suggests, the central piece of the technology described herein is a personal registry of access keys rather than a personal record of actual health data. Each access key is generated and digitally signed by a healthcare facility that allows access to the person's own EHR record at that facility. For example, each key may contain the patient's name, date of birth, gender and the patient's unique ID at the facility. It will be encrypted and digitally signed by the facility's own credentials so that only this facility will be able to decrypt the content of the access key. Furthermore, each access key should also have Universal Resource Locators (URLs) that specify a link to the facility that issues this key and links to services where actual data can be obtained (see FIG. 1).

Referring to FIG. 1, central key server 100 includes patient controlled registries 102₁ and 102₂ of access keys that control access to patient health information maintained by data servers of healthcare or other health data facilities 104₁-104₄. Central key server 100 includes a request processor 106 for receiving, from a data server of a facility 104₁, a request for an access key that controls access to information for a patient maintained by a second healthcare facility 104₂. In response to the request, request processor 106 locates, in patient controlled registry 102₁, an access key for health information at healthcare facility 104₂. The access key is usable by healthcare facility 104₁ for obtaining health information for the patient directly from healthcare facility 104₂.

In one embodiment, central key server 100 may implemented as a cluster of distributed servers that perform the functions described herein for a central key server in a reliable manner. For example, each central key server in the cluster may maintain the same copies of patient controlled registries 102 so that if one central key server in the cluster fails, requests can be routed to an alternate central key server in the cluster.

In FIG. 1, each patient may have an account through which the patient maintains his or her own registry of access keys with central key server 100. The access keys maintained by central key server 100 may be received from healthcare facilities previously visited by the patient and with the patient's permission to share the medical image and other health data. In one implementation, each patient may have an account with central key server 100, referred to herein as a PCARE account. With a PCARE account, when a patient requests a facility to share his/her imaging data; the facility pushes or uploads only the access key to the PCARE account, rather than the actual image data. It will be up to the next facility that cares for the patient to retrieve the actual imaging data directly from previous facilities using the access keys maintained in the PCARE account. For security reasons, the facility may update the access key periodically. The facility must also update the access key when relevant information changes, for example, when facility's URLs change.

In addition to access keys, each PCARE account also maintains an audit log of how the keys are used for health data access. The audit history not only is important for HIPAA regulations in the United States, but also provides useful information for users to manage their own care experience.

The size of each PCARE account is small since each access key has a limited size and the audit log is composed of simple text information. The small size of PCARE accounts makes it possible to scale the PCARE infrastructure to easily handle tens of millions of users nationwide.

Typical design of a PCARE infrastructure consists of a single web-based portal system, called PCARE Portal, and a number of software agents, one for each facility. Functionality of the PCARE Portal may include:

User creation and management

Interface with providers to receive new and updated access keys

Interface with providers to deliver access keys with user permission

Audit trails for all use of access keys

User interface for managing access keys

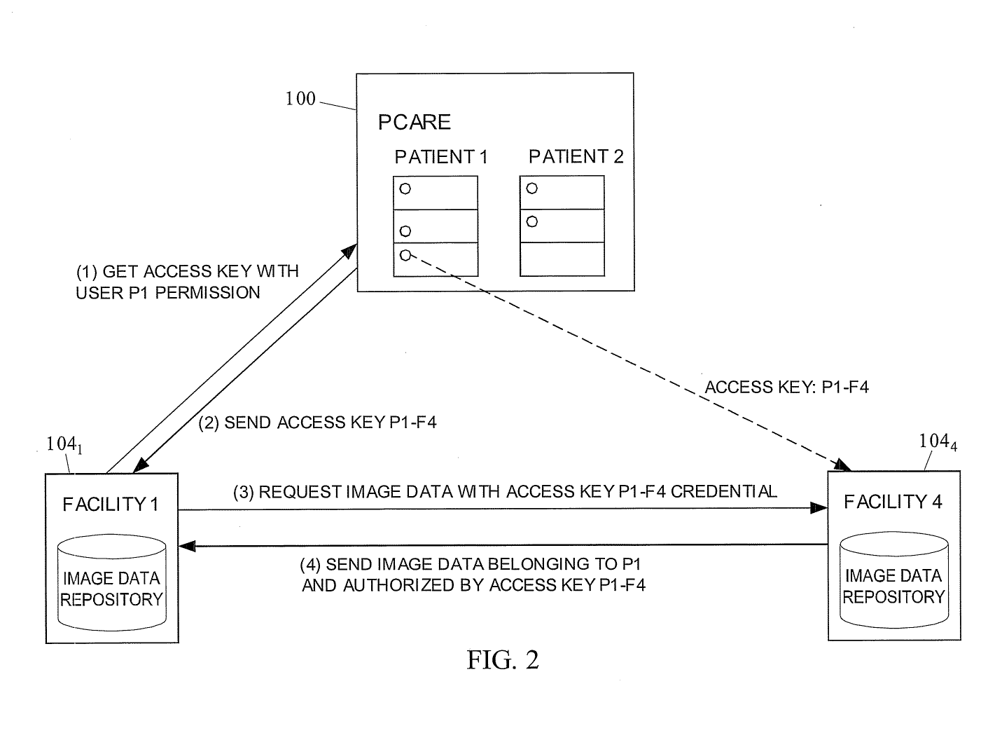

FIG. 2 illustrates exemplary patient mediated access to health data according to an embodiment of the subject matter described herein. In FIG. 2, using the concept of PCARE, image sharing takes place in a two-level protocol. When a patient requests image sharing, the data server of facility 104₁ pushes an access key to PCARE. Then when another facility 104₁ needs to access the actual imaging data, with permission from the patient, it will first retrieve from central key server 100 the access key issued by facility 104₁ and then request imaging data directly from facility 104₁ using the access key and its own credentials. After facility 104₁ verifies that facility 104₄ is a legitimate healthcare provider and the access key is indeed issued by facility 104₁, it will then extract identity and authorization information from the access key, retrieve the imaging data from its repositories and respond to facility 104₄ with the data.

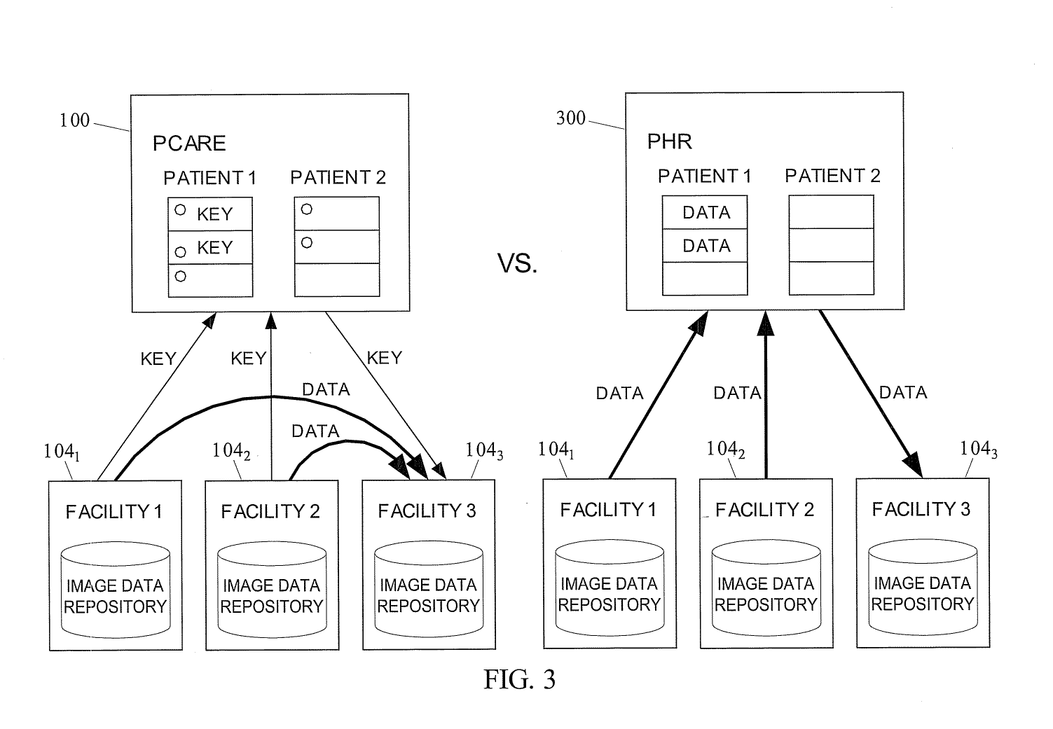

FIG. 3 illustrates the major differences between PCARE and PHR based image sharing. In FIG. 3, the thin arrows indicate the flow of access keys while the thick arrows indicate the flow of actual imaging data. In the diagram on the left hand side of FIG. 3, keys are shared between central key server 100 and facilities 104₁-104₃. Healthcare data is provided directly between facilities. In the diagram on the right hand side of FIG. 3, personal health record data is managed and stored from all facilities at a central repository 300. As a result, when one facility wants to access a patient's health data, the data must be accessed at central repository 300, rather than directly between facilities. While the diagrams may not look very different, the benefits of the PCARE approach are significant. In addition to reducing the network bandwidth for image transferring and the storage needs in the centralized patient record, the PCARE approach maintains the actual data at the data source making it possible for the source facilities to correct mistakes and notify requesting facilities promptly. The fact that the health data are communicated directly between the healthcare providers also makes it possible for providers to request additional information that otherwise would not be appropriate for direct correspondence to patients. Furthermore, as will be discussed below, the PCARE approach naturally lends to a card-based implementation that will truly enable image (and other health data) sharing by every patient regardless of their economical, technological and geographical difference.

Returning to FIG. 1, each facility may include an agent 108 that executes on one of its data servers or that executes on a separate computing platform from its data servers. Agent 108 at each facility is responsible for generating, submitting and updating access keys. In one exemplary implementation, each agent 108 is run on a server that is accessible from both inside and outside the facility's firewall. This type of server is often called an edge server. In addition to agent 108, the edge server usually serves multiple relevant functions. Each agent 108 works with a Facility Portal that allows patients to create personal accounts that are linked to their local EHR at the facility. This local account on the Facility Portal provides the necessary linkage between the PCARE account and the actual EHR data in provider facilities. And the identity of this local account usually constitutes the main body of an access key.

A production PCARE system allows users to request image sharing and specify both PCARE and facility identities in various ways, including physical presence, phone, fax and online mechanisms. In one exemplary implementation, an online web-based mechanism is provided. A card-based mechanism is also located herein. For the web-based mechanism, a Facility Portal on the edge server with functions to manage local user accounts that contain at the minimum a link to the facility's EHR and a software agent that submits access keys to the PCARE portal. Users can use this portal to request image sharing online and manage the generation and updating of access keys online.

National standards can be adopted in all aspects of the project. In particular, for access control and identity management in PCARE, we may use the Security Assertion Markup Language (SAML) and SAML profiles from OASIS. SAML is also a standard used in the secure integration profiles proposed by Integrating Healthcare Enterprises (IHE). Using the SAML model, the PCARE Portal functions as an Identify Provider (IdP) while the Facility Portal in a provider facility acts as a Service Provider (SP). The process of linking PCARE accounts with users' facility accounts is essentially the Identity Federation use case scenario enabled by the SAML framework.

At the service level, the PCARE Portal serves as a composite Document Registry and Document Repository actor while the Facility Portal is a Document Source in the IHE standards framework (FIG. 2). More particularly, FIG. 2 illustrates image sharing between the data server of facility 104₁ and the data server of facility 104₄. Referring to FIG. 2, the data server of facility 104₁ requests an access key with the permission from patient P1. Central key server 100 verifies the permission and sends the access key for patient P1's records at facility 104₄. In the third step, the data server of facility 104₁ requests image data with the access key for patient P1's records at facility 104₄ and includes facility 104₁'s credentials. In step 4, the data server of facility 104₄ sends the image data belonging to patient P1 and authorized by the access key P1-F4. The IHE Cross Enterprise Document Sharing (XDS), Audit Trail and Node Authentication (ATNA) and Consistent Time (CT) integration profiles can be implemented and customized, where necessary (e.g., document source registration is now user driven) to ensure that all components are designed in a standard, secure and HIPAA compliant manner.

The PCARE infrastructure described above can be implemented to enable image sharing in a two-level protocol. First, the PCARE Portal must provide a service for secure retrieval of access keys with user permission. This can be achieved in a number of ways. One possibility is to allow a user to make authorization in PCARE portal which requires the facilities to have accounts in PCARE portal. Another possibility is to allow a user to log in and provide permission at point of care, i.e., the Facility Portal as the initiating application. At the Facility Portal, the user first establish and log in to a local account and then perform account linking to establish federated identity with the PCARE portal. Upon receiving a request for patient registry using the patient's federated identity. PCARE first responds with a list of meta data about the access keys. Then after the patient selects one or more access keys at the facility portal, a set of actual access keys are forwarded to the Facility Portal, possibly requiring a PIN number for individualized access key control. Audit log will be recorded according to the requirements of HIPAA regulations possibly using the IHE ATNA profile.

The Facility Portals will do most of the work in this model. The requesting Facility Portal should provide at the minimum the following functions:
Initiate image sharing using patient's access key and facility's own site credentials
Retrieve image meta data for display and selection
Retrieve selected images asynchronously
Serve as an local image server (DICOM AE) for query and retrieval by review workstations
Clear images after expiration

The responding Facility Portal should provide at the minimum the following functions:
Verify the access key and site credentials of incoming requests
Search and retrieve medical data from local EHR based on patient identity and authorization constraints
Send image meta data per request
Serve image data for downloading or streaming

For finer access control, we may also allow a user to define access control at the study or even series level. This can be achieved by generating multiple access keys at the responding Facility Portal, each with a different set of permissions.

High level design of the PCARE image sharing infrastructure will use the IHE Cross Community Access (XCA) Technical Framework as the basis. Briefly, the requesting Facility Portal will implement the Initiating Gateway, Document Consumer and Imaging Document Source. The responding Facility Portal will implement the Responding Gateway, Document Registry, Document Repository and Imaging Document Consumer.

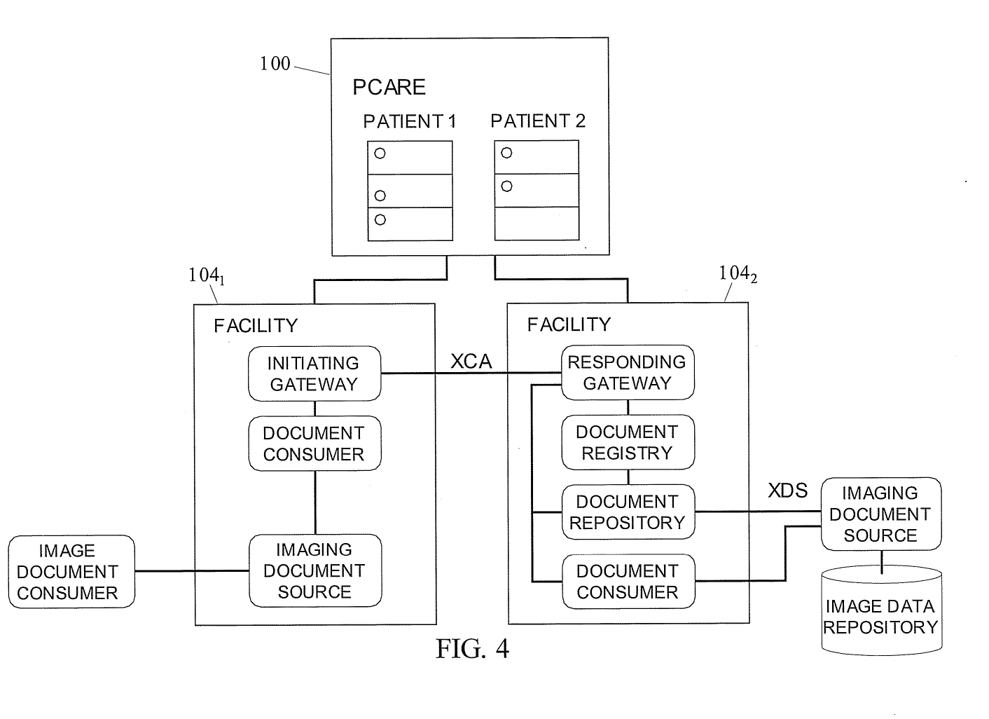

As shown in FIG. 4, the responding Facility Portal of facility 104₁ or 104₂ also implements the XDS framework that integrates the Document Registry and Repository with internal clinical PACS systems. When new images arrive at a clinical PACS, image meta data will be submitted to the Document Registry and the Document Repository. The meta data can then be queried by the requesting Facility Portal. For retrieving requests, the responding Facility Portal will act as the Document Consumer to retrieve image data from clinical PACS first, and then send the image data to the requesting side via two gateways. Note that each facility in this diagram can also be the common infrastructure of an affinity domain in the XDS framework.

PCARE Card—Image Sharing for Everyone

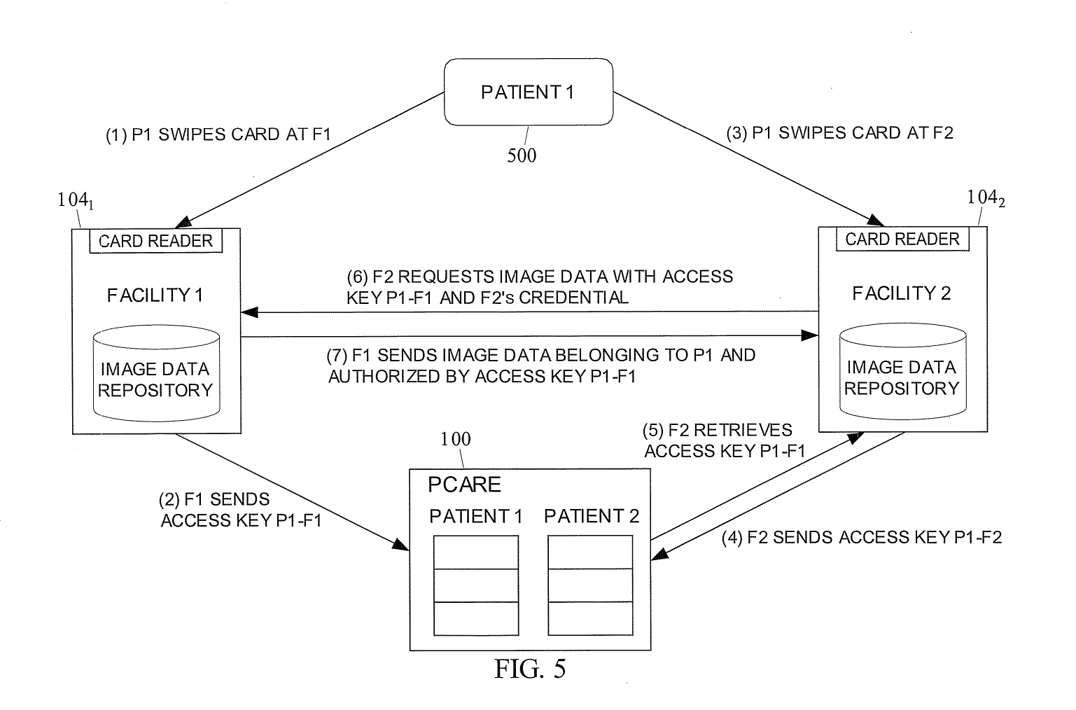

According to another aspect of the subject matter described herein, each patient may maintain a card, having the form factor of a credit card, for storing and managing the patient's key registry. FIG. 5 illustrates such an embodiment. In FIG. 5, a patient 500 may have a card similar to a credit card for authentication information required to access the PCARE Portal and potentially some high level information related to access keys for patient data stored at different facilities. The patient's card is referred to herein as a PCARE card.

A PCARE Card is essentially a credit card for health data. A PCARE account at a PCARE card organization is comparable to a credit account at one of the credit card companies. The EHR and imaging data repository at each healthcare provider can be considered a bank of health data. When a PCARE card is issued to and activated by a patient, a PCARE account is automatically created. The card establishes a unique identity for the patient. When the patient goes to a healthcare facility, swiping of the PCARE card at the reception desk triggers three actions:
1. An access key to the patient's account at the current local facility is uploaded to the patient's PCARE account with default authorization rules. This is analogous to adding a credit to the account for future sharing
2. A list of existing access keys from previous facilities in the PCARE account is retrieved and displayed to the patient for permission to share; potentially requiring a PIN
3. Selected access keys are used to retrieve relevant imaging data from other facilities as described in the previous section

This flow is illustrated in FIG. 5. Here Patient P1 500 visits facility F1 104₁, first. Swiping of his/her PCARE card at that encounter triggers an access key P1-F1 to be submitted to P1's PCARE account. Then when P1 visits another facility F2 104₂ at a later time, swiping of his/her PCARE card allows F2 to obtain all the imaging data acquire at F1.

PCARE is uniquely suited for a card-based mechanism because the data exchanged during a card swipe are authentication information rather than real data. This is a major difference between our approach and prior proposals for card-based access to health data and services. The cards used in ideas such as PHRs (or Health Record Banks [3]) and Health Passports [4] are like debit (or ATM) cards. Swiping a card enables a transaction of sending or retrieving actual health data. In contrast, the cards used here are more like credit cards. The swiping of a card transfers access keys (i.e. credits). It is then up to the access key holder to decide when to retrieve data and how much. We contend that our approach is much more efficient and flexible to manage and much more convenient for users.

We anticipate that for most people, the PCARE card will become the only mechanism needed for sharing imaging data (and indeed all health data). As long as the patient swipes the card at each encounter, all his/her health data from previous visits to other providers can be made available to the current provider, with a simple process for patient consent.

For patients who desire advanced permission and management of health data, the web portals described in the previous section will allow them personally manage the PCARE account and all related local facility accounts.

Except for the card and card reader, the PCARE image sharing infrastructure is basically the same. However, a parallel customer support infrastructure will be needed to handle the issuing and canceling of cards. There may also be a need for Automatic Teller Machine (ATM) type kiosks to allow users transfer imaging data prior to upcoming visits or perform the management of their accounts without a personal computer.

Just like credit cards, the PCARE card based infrastructure must include mechanisms to detect and handle card frauds. However, we anticipate much less fraud in PCARE card use because the facilities that are allowed request for image sharing can be tightly controlled, verified and audited.

PHR with PCARE

The use of PCARE cards makes it extremely convenient for users to acquire access keys into PCARE accounts. Future PHRs that are based on the PCARE infrastructure will be much more user friendly. These PHRs can then serve as additional source for health data sharing using the same PCARE infrastructure.

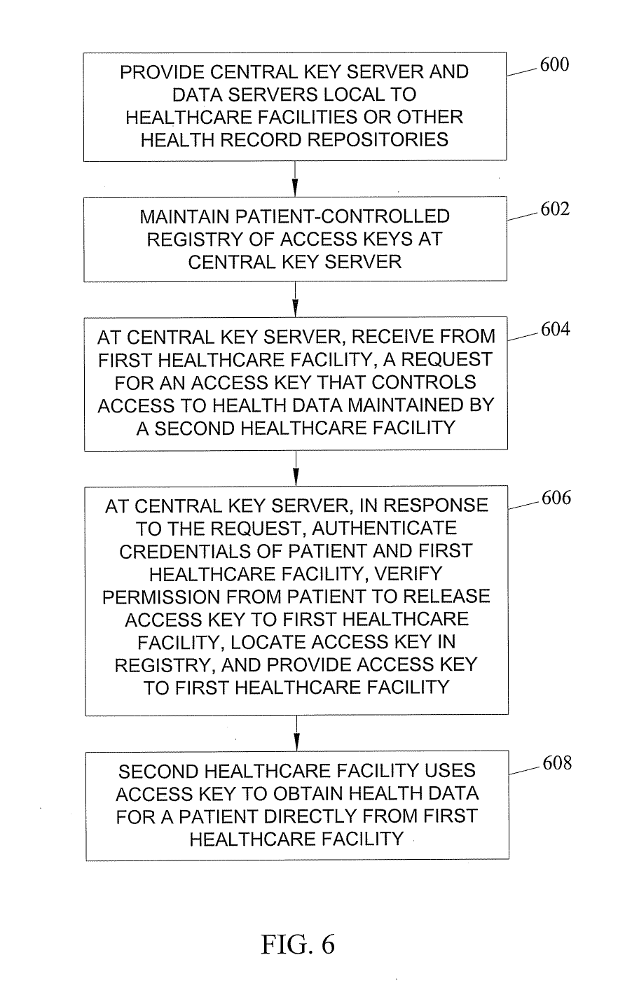

FIG. 6 is a flow chart illustrating exemplary overall steps for patient mediated access to patient health information maintained by different healthcare facilities or other record repositories. Referring to FIG. 6, in step 600, a central key server and a plurality of data servers local to healthcare facilities or health record repositories are provided. In step 602, at the central key server, a patient controlled registry of access keys that control access to patient health information maintained by different healthcare facilities is maintained. In step 604, the central key server receives, from a first healthcare facility, a request for an access key that controls access to health information for a patient maintained by a second healthcare facility. In step 606, the central key server, in response to the request, authenticates credentials of the patient and the first healthcare facility, verifies permission from the patient to release the access key to the first healthcare facility, locates, in the patient controlled registry, the access key for the health information for the patient at the second healthcare facility, and provides the access key to the first healthcare facility. In step 608, the access key is used by the second healthcare facility to obtain health information for the patient directly from the data server of the second healthcare facility and transfer the requested data to the first healthcare facility after successful authentication of the first healthcare facility using the access key and verification of access permissions granted by the patient.

In one embodiment of the subject matter described herein, access keys issued by the different healthcare facilities may be digitally signed by the facilities, using any suitable digital signature technique, such as signing with the private key of the healthcare facility in a PKI encryption scheme.

According to another aspect of the subject matter described herein, each of the access keys may include a URL that identifies the data server of the healthcare facility that issues the key and a service of the facility through which the health information can be obtained. A given healthcare facility may issue plural access keys for a single patient that give access to different parts of healthcare records of a given patient. For example, a facility may include one access key for medical image data for a patient and another access key for lab test results for the patient. Health information for a patient may include a variety of data, in addition to medical image data. For example, the health information that is maintained at a given facility may include the patient's electronic health record (EHR), health records collected by health maintenance facilities of the patient, health records entered and maintained by the patient or the guardians of the patient with power of attorney privilege, or health information dictated or entered by the patient's physician.

As set forth above, when a given healthcare facility requests health information for a given patient, the central key server verifies permission using information in the request. Verifying permission may include checking permission statements from an access key record of the patient stored at the central key server. The request for an access key maintained in the registry of a patient may be generated in response to a manual request by a facility or in response to reading a patient controlled access registry card. The card may be any one of a magnetic stripe card, a smart card, or other secure portable access device.

Once the data server of one healthcare facility obtains health information from another healthcare facility using the techniques described herein, the receiving healthcare facility may store the obtained health information to allow access by healthcare professionals at that facility. This eliminates the problems associated with conventional methods where repeated requests to a central repository are required.

In order to support a revenue model, the central key server together with the facility level software agents may maintain billing records that track each healthcare facility's access to the central key database and transfer of medical image and other health data. The central key server may also maintain corresponding charges for each access.

The disclosure of each of the following references is hereby incorporated herein by reference in its entirety.
[1] D. Mendelson, P. Bak, E. Menschik, and E. Siegel, “Image Exchange: IHE and the Evolution of Image Sharing,” Radiographics, vol. 28, pp. 1817-1833, 2008.
[2] K. Mandl and I. Kohane, “Tectonic Shifts in the Health Information Economy,” New England Journal of Medicine, vol. 356, no. 16, pp. 1732-1737, 2008.
[3] R. Dettinger, D. Kolz, and R. Stenves, “Checkbook to control access to health record bank account,” USA Patent 20070075135, 2007.
[4] N. Pindus, B. Selter, R. Koralek, C. Owens, and J. Bernstein, “The Health Passport Project: Assessment and Recommendations,” The Urban Insttitue and MAXIMUS, Washington, D.C., 2001.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for patient-mediated access to patient health information maintained by different healthcare facilities or other health record repositories, the method comprising:
using a central key server and plurality of data servers local to the healthcare facilities or other health record repositories:
at the central key server, maintaining a patient-controlled registry of access keys that control access to patient health information maintained by different healthcare facilities;
receiving, at the central key server and from the data server of a first healthcare facility, a request for an access key that controls access to health information for a patient maintained by a second healthcare facility; and
at the central key server, in response to the request, authenticating credentials of the patient and the first healthcare facility, verifying permission from the patient to release the access key to the first healthcare facility, locating, in the patient-controlled registry, the access key for the health information for the patient at the second healthcare facility and providing the access key to the first healthcare facility, wherein the access key is used by the data server of the first healthcare facility to obtain the health information for the patient directly from the data server of the second healthcare facility after successful authentication of the first healthcare facility using the access key and verification of access permissions granted by the patient.

2. The method of claim 1 wherein the access keys maintained by the central key server are received from healthcare facilities previously visited by the patient and with the patient's permission to share the health information.

3. The method of claim 1 the access keys are issued by the data servers of the healthcare facilities and are digitally signed by the facilities.

4. The method of claim 1 wherein the data server of each healthcare facility is accessible by patients to request the creation of access keys for at least a portion of the health records of the patient at each healthcare facility and the submission of the access keys to the central key server.

5. The method of claim 1 wherein the data server of each healthcare facility, with permission of the patient, has secure access to at least a portion of the health information of the patient stored at the facility.

6. The method of claim 1 wherein each of the access keys includes a universal resource locator (URL) that identifies the data server of the healthcare facility that issues the key and a service of the facility through which the health information can be obtained.

7. The method of claim 1 wherein each healthcare facility issues a plurality of access keys that enables access to various parts of healthcare records of a patient.

8. The method of claim 1 wherein the health information for the patient includes medical image data.

9. The method of claim 1 wherein the health information for the patient includes an electronic health record (EHR).

10. The method of claim 1 wherein the health information for the patient includes health related records collected by health maintenance facilities of the patient.

11. The method of claim 1 wherein the health information for the patient includes health related records entered and maintained by the patient and guardians of the patient with power of attorney privilege.

12. The method of claim 1 wherein verifying the permission includes verifying the permission using information in the request received from the data server of first healthcare facility.

13. The method of claim 1 wherein verifying the permission includes checking the permission statements from an access key record of the patient stored at the central key server.

14. The method of claim 1 wherein receiving the request includes receiving a request for a list of access keys maintained in the registry for the patient in response to the reading of a patient-controlled health information access registry card by a card reader at the first healthcare facility; and receiving selection of at least one key from the list for providing access to the patient controlled health information.

15. The method of claim 14 wherein the health information access registry card comprises one of: a magnetic stripe card, a smart card, or other secure portable access device.

16. The method of claim 1 wherein the data server of the second healthcare facility maintains the health information of the patient in data storage accessible directly by the data server of the second healthcare facility.

17. The method of claim 1 wherein the data server of the second healthcare facility retrieves the health information of the patient from a local health information server comprising one of: an Electronic Medical Record (EMR), a Picture Archiving and Communications System (PACS), a Hospital Information System (HIS), or a Radiology Information System (RIS).

18. The method of claim 1 wherein the data server of the first healthcare facility maintains the health information of the patient received from the second healthcare facility and enables access by authorized healthcare professionals at the first healthcare facility.

19. The method of claim 18 wherein the data server of the first healthcare facility submits the health information of the patient received from the second healthcare facility to a local health information system of the first healthcare facility which then maintains and enables access to the health information of the patient by authorized healthcare professionals at the first healthcare facility.

20. The method of claim 1 wherein the central key server maintains billing records that track each healthcare facility's access to the central key server and corresponding charges for the accesses.

21. The method of claim 1 wherein the central key server maintains plural access keys for a patient for a given facility, wherein the keys for the given facility respectively control access to different types of health information for the patient within the facility.

22. A system for patient-mediated access to patient health information maintained by different healthcare facilities, the system comprising:
a plurality of data servers associated with different healthcare facilities for storing patient health information generated by the facilities;
a central key server including a patient controlled registry of access keys that control access to patient health information maintained by the data servers of the different healthcare facilities;
the central key server including a request processor for receiving, from a data server of first healthcare facility, a request for an access key that controls access to health information for a patient maintained by a second healthcare facility and in response to the request, for locating, in the patient-controlled registry, an access key for the health information for the patient at the second healthcare facility and for providing the access key to the first healthcare facility, wherein the access key is usable by the first healthcare facility to obtain the health information for the patient directly from the second healthcare facility after successful authentication of the first healthcare facility using the access key and verification of access permissions granted by the patient.

23. The system claim 22 wherein the access keys maintained by the central key server are received from healthcare facilities previously visited by the patient and with the patient's permission to share the medical image and other health data.

24. The system of claim 23 the access keys are issued by the healthcare facilities and are digitally signed by the facilities.

25. The system of claim 23 wherein the data server of each healthcare facility is accessible by patients to request the creation of access keys for at least a portion of the health records of the patient at each healthcare facility and the submission of the access keys to the central key server.

26. The system claim 23 wherein the data server of each healthcare facility, with the permission of the patient, has secure access to at least a portion of the health information of the patient stored at the facility.

27. The system of claim 23 wherein each of the access keys includes a universal resource locator (URL) that identifies the healthcare facility that issues the key and a service of the healthcare facility from which the health information can be obtained.

28. The system of claim 23 wherein each healthcare facility issues a plurality of access keys that enables access to various parts of healthcare records of a patient.

29. The system of claim 23 wherein the health information for the patient includes medical image data.

30. The system of claim 23 wherein the health information for the patient includes an electronic health record (EHR).

31. The system of claim 23 wherein the health information for the patient includes health related records collected by health maintenance facilities of the patient.

32. The system of claim 23 wherein the health information for the patient includes health related records entered and maintained by the patient and guardians of the patient with power of attorney privilege.

33. The system of claim 23 wherein verifying the permission includes verifying the permission using information in the request received from the data server of first healthcare facility.

34. The system claim 23 wherein verifying the permission includes checking the permission statements from an access key record of the patient stored at the central key server.

35. The system of claim 23 wherein receiving the request includes receiving the request from a facility portal accessible via the first healthcare facility.

36. The system of claim 23 comprising a card reader located at the first healthcare facility for allowing a patient to swipe a personally controlled registry card, access a list of keys from the registry of the patient, and select the key to provide to the first healthcare facility from the list.

37. The system of claim 36 wherein the health information access registry card comprises one of: a magnetic stripe card, a smart card, or other secure portable access device.

38. The system of claim 23 wherein the data server of the second healthcare facility maintains the health information of the patient in data storage accessible directly by the data server of the first healthcare facility after the successful authentication and verification.

39. The system of claim 23 wherein the data server of the second healthcare facility retrieves the health information of the patient from a local health information server comprising one of: an Electronic Medical Record (EMR), a Picture Archiving and Communications System (PACS), a Hospital Information System (HIS), or a Radiology Information System (RIS).

40. The system of claim 23 wherein the data server of the first healthcare facility maintains the health information of the patient received from the second healthcare facility and enables access by authorized healthcare professionals at the first healthcare facility.

41. The system of claim 40 wherein the data server of the first healthcare facility submits the health information of the patient received from the second healthcare facility to a local health information system of the first healthcare facility which then maintains and enables access to the health information of the patient by authorized healthcare professionals at the first healthcare facility.

42. The system of claim 23 wherein the central key server maintains billing records that track each healthcare facility's access to central key database and corresponding charges for the accesses.

43. The system of claim 23 wherein the central key server maintains plural access keys for a patient for a given facility, wherein the keys for the given facility respectively control access to different types of health information for the patient within the facility.

44. The system of claim 23 wherein the central key server is physically implemented as a cluster of distributed servers that perform the function of the central key server in a reliable manner.

45. A computer readable medium having stored thereon executable instructions that when executed by the processor of a computer control the computer to perform steps comprising:
using a central key server and plurality of data servers local to the healthcare facilities and other health record repositories:
at the central key server, maintaining a patient-controlled registry of access keys that control access to patient health information maintained by different healthcare facilities;
receiving, at the central key server and from the data server of a first healthcare facility, a request for an access key that controls access to health information for a patient-maintained by a second healthcare facility; and
at the central key server, in response to the request, authenticating credentials of the patient and the first healthcare facility, verifying permission from the patient to release the access key to the first healthcare facility, locating, in the patient-controlled registry, the access key for the health information for the patient at the second healthcare facility and providing the access key to the first healthcare facility, wherein the access key is used by the data server of the first healthcare facility to obtain the health information for the patient directly from the data server of the second healthcare facility after successful authentication of the first healthcare facility using the access key and verification of access permissions granted by the patient.
